(19) United States
(12) Patent Application Publication
(10) Pub. No.: US 2016/0241777 A1
(43) Pub. Date: Aug. 18, 2016

(54) METHOD AND SYSTEM FOR IMPLEMENTING A USER INTERFACE FOR CAPTURING VIDEOS AND PHOTOS ON CAMERAS WITH A TOUCH SCREEN

(71) Applicant: MAGISTO LTD., Nes-Ziona (IL)

(72) Inventors: Alexander RAV-ACHA, Rehovot (IL); Oren BOIMAN, Sunnyvale, CA (US)

(21) Appl. No.: 15/043,680

(22) Filed: Feb. 15, 2016

Related U.S. Application Data
(60) Provisional application No. 62/116,694, filed on Feb. 16, 2015.

(51) Int. Cl. H04N 5/232; G06F 3/0486; G06F 3/0488

(52) U.S. Cl. CPC H04N 5/23216; G06F 3/0488; G06F 3/0486; H04N 5/23245; H04N 5/23293

(57) ABSTRACT

A method and a system for implementing a user interface for capturing videos and photos on cameras with a touch screen are provided herein. The method may include: presenting on a touch screen a capturing control button; responsive to a tap of the capturing control button, instructing a capturing device to capture a still image; responsive to a continuous touch of the capturing control button, instructing the capturing device to capture a video footage throughout the continuous touch; and responsive to a displacement movement applied to the capturing control button, instructing the capturing device to capture a video footage until a reverse displacement movement is applied to the capturing control button. The system may implement the aforementioned method on a smartphone.

### CROSS-REFERENCE TO RELATED APPLICATIONS

This Application claims priority from U.S. Provisional Patent Application No. 62/116,694, filed Feb. 16, 2015, which is incorporated herein by reference in its entirety.

### FIELD OF THE INVENTION

The present invention relates generally to the field of capturing still image and video footage, and more particularly to a user interface implemented on a touch screen for capturing same.

### BACKGROUND OF THE INVENTION

The common length of videos being captured by cameras, especially cameras embedded in smartphones, have been changed over the past years. Many mobile applications enable today a user of a smartphone to capture only a few seconds of video. These applications such as Vine, provide various use cases for capturing extremely short videos in the order of 6 second videos.

It would, therefore, be advantageous to be able to implement a user interface for cameras with a touch screen such as smartphones that enable both long and short video recording, as well as shooting photos.

### SUMMARY OF THE INVENTION

In accordance with some embodiments of the present invention, a method and a system for implementing a user interface for capturing videos and photos on cameras with a touch screen are provided herein. The method may include: presenting on a touch screen a capturing control button; responsive to a tap of the capturing control button, instructing a capturing device to capture a still image; responsive to a continuous touch of the capturing control button, instructing the capturing device to capture a video footage throughout the continuous touch; and responsive to a displacement movement applied to the capturing control button, instructing the capturing device to capture a video footage until a reverse displacement movement is applied to the capturing control button. The system may implement the aforementioned method on a smartphone.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating a non-limiting exemplary system in accordance with embodiments of the present invention;

FIG. 2 is a diagram illustrating an exemplary user interface of a touchscreen in accordance with embodiments of the present invention;

FIG. 3 is a diagram illustrating another exemplary user interface of a touchscreen in accordance with embodiments of the present invention; and

FIG. 4 is a flowchart diagram illustrating a non-limiting exemplary method in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

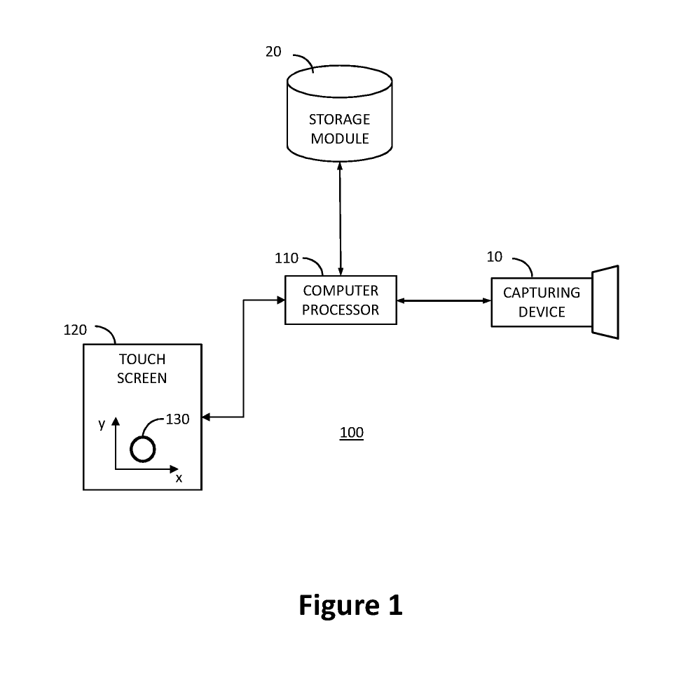

FIG. 1 is a block diagram illustrating a non-limiting exemplary system in accordance with embodiments of the present invention. System 100 includes a capturing device 10 such as a camera, a touch screen 120, a computer processor 110 and possibly a storage module 20.

In operation, computer processor 110 is configured to: present on the touch screen a capturing control button 130 (shown on an x-y plane of the touch screen); responsive to a tap of the capturing control button 130, instruct capturing device 10 to capture a still image; responsive to a continuous touch of the capturing control button 130, instruct capturing device 10 to capture a video footage throughout the continuous touch; and responsive to a displacement movement applied to the capturing control button 130, instruct capturing device 10 to capture a video footage until a reverse displacement movement is applied to the capturing control button 130. Storage module 20 is configured to store the captured still images, short and long video footages captured.

According to some embodiments of the present invention, capturing control button 130 is configured to visually indicate throughout the capturing that a video footage is being captured by the capturing device.

According to some embodiments of the present invention, capturing control button 130 may be configured to move to a proximal location on the touch screen responsive to the displacement movement applied thereto.

According to some embodiments of the present invention, the displacement movement may include dragging capturing control button 130 from a first location to a second location on the touch screen, and wherein the reverse displacement movement comprises dragging the capturing control button from the second location to the first location on the touch screen.

According to some embodiments of the present invention, capturing control button 130 may be configured to visually indicate that a video footage is being captured by changing a color or appearance thereof.

According to some embodiments of the present invention, capturing device 10, touch screen 120 and the computer processor 110 are implemented as a part of a smartphone.

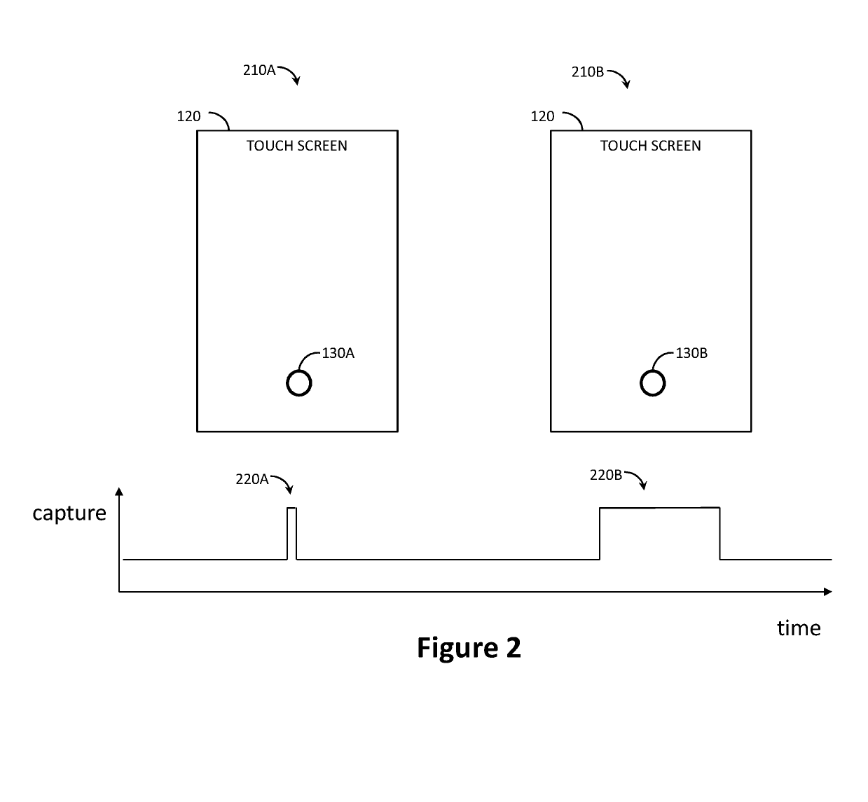

FIG. 2 is a diagram illustrating an exemplary user interface of a touchscreen in accordance with embodiments of the present invention. View 210A shows touchscreen 120 with capturing control button 130A. Whenever capturing control button 130A is tapped, as shown in the time diagram below at point 220A, the capturing device captures a still image.

View 210B shows touchscreen 120 with capturing control button 130B in a second embodiment. Whenever capturing control button 130B is touched, and throughout the duration of the touch, the capturing device captures a video footage, as shown in the time diagram in duration 220B.

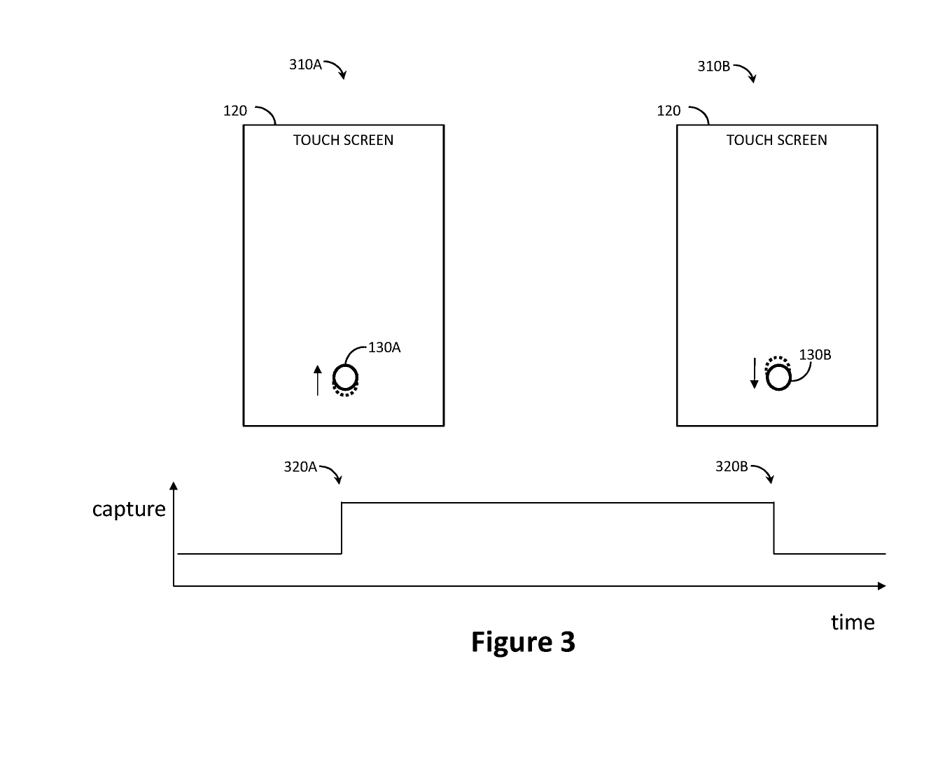

FIG. 3 is a diagram illustrating another exemplary user interface of a touchscreen in accordance with embodiments of the present invention. View 310A shows touchscreen 120 with capturing control button 130A. Whenever capturing control button 130A is displaced, e.g. by dragging it from its original position indicated by a dashed circle to a second position marked by the diagonal pattern circle, the capturing device is locked in a video capturing mode in which the capturing device captures a video footage without any further touch action by the user.

View 310B shows touchscreen 120 with capturing control button 130B upon release from the locked video capturing mode. Whenever capturing control button 130B is dragged back from the active position marked in a dashed circle to its original position marked by a plain white circle, the capturing device ceases to capture the video footage. This is illustrated in the time diagram showing the video capturing lock mode starting at point 320A and ending at point 320B.

Advantageously, by some embodiments of the present invention, the capturing of long and short videos, as well as taking photos, are all carried out and achieved by using a single capturing control button (whose design can be a simple common design, such as the circle in the non-limiting example herein). The behavior of capturing control button is as follows:
Tapping on the ‘capture’ button results in taking a photo.
Holding the ‘capture’ button pressed, results in capturing a short video, which records the moments in which the button was pressed down. This flow is most suitable for capturing short videos, as it lets the user to record a video without tapping twice.
Dragging the button up or down, results in ‘locking’ the button, and thus initializing an action of taking a video, until this button is ‘released’ by the user by dragging it down back to its original location. This flow is most suitable for long videos, as the finger doesn't need to be pressed all the time when recording of the video.

It should be noted that (similarly to many other capturing user interfaces) the recording operation can be accompanied by other graphical components and visualizations, that can be used, for example, for displaying additional information regarding the capturing assets or the capturing operation.

In accordance with some embodiments of the present invention, the additional graphical components and visualizations may include:
The capture button changes its color during capturing a video (for long capture it also changes it shape to be non-filled circle).
The duration of the video being captured is shown in a different pane.
A thumbnail of the photo/video being taken is also shown in a different pane.

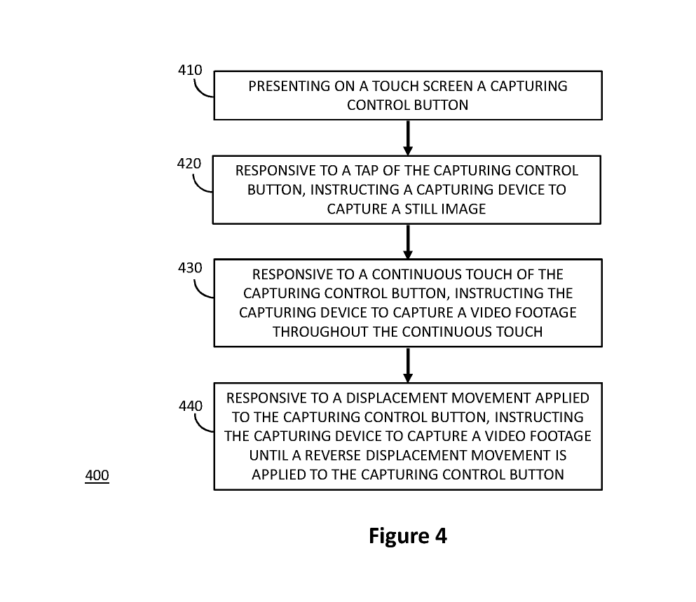

FIG. 4 is a flowchart diagram illustrating a non-limiting exemplary method in accordance with embodiments of the present invention. Method 400 may include: presenting on a touch screen a capturing control button 410; responsive to a tap of the capturing control button, instructing a capturing device to capture a still image 420; responsive to a continuous touch of the capturing control button, instructing the capturing device to capture a video footage throughout the continuous touch 430; and responsive to a displacement movement applied to the capturing control button, instructing the capturing device to capture a video footage until a reverse displacement movement is applied to the capturing control button 440.

According to some embodiments of the present invention, the capturing control button may be configured to visually indicate video footage capturing of the capturing device throughout the capturing.

According to some embodiments of the present invention, the capturing control button may be configured to move to a proximal location on the touch screen responsive to the displacement movement applied thereto.

According to some embodiments of the present invention, the displacement movement may include dragging the capturing control button from a first location to a second location on the touch screen, and wherein the reverse displacement movement comprises dragging the capturing control button from the second location to the first location on the touch screen.

According to some embodiments of the present invention, the capturing control button may be configured to visually indicate the video footage capturing by changing a color thereof

In accordance with embodiments of the present invention, method 400 may be implemented as a non-transitory computer readable medium which includes a set of instructions, when executed, cause the least one processor to: present on a touch screen a capturing control button; responsive to a tap of the capturing control button, instruct a capturing device to capture a still image; responsive to a continuous touch of the capturing control button, instruct the capturing device to capture a video footage throughout the continuous touch; and responsive to a displacement movement applied to the capturing control button, instruct the capturing device to capture a video footage until a reverse displacement movement is applied to the capturing control button.

In order to implement the method according to some embodiments of the present invention, a computer processor may receive instructions and data from a read-only memory or a random access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in base band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method comprising:
presenting on a touch screen a capturing control button;
responsive to a tap of the capturing control button, instructing a capturing device to capture a still image;
responsive to a continuous touch of the capturing control button, instructing the capturing device to capture a video footage throughout the continuous touch; and
responsive to a displacement movement applied to the capturing control button, instructing the capturing device to capture a video footage until a reverse displacement movement is applied to the capturing control button.

2. The method according to claim 1, wherein the capturing control button is configured to visually indicate throughout the capturing that a video footage is being captured by the capturing device.

3. The method according to claim 1, wherein the capturing control button is configured to move to a proximal location on the touch screen responsive to the displacement movement applied thereto.

4. The method according to claim 1, wherein the displacement movement comprises dragging the capturing control button from a first location to a second location on the touch screen, and wherein the reverse displacement movement comprises dragging the capturing control button from the second location to the first location on the touch screen.

5. The method according to claim 2, wherein the capturing control button is configured to visually indicate that a video footage is being captured by changing a color or appearance thereof.

6. A system comprising:
a capturing device,
a touch screen, and
a computer processor configured to:
present on the touch screen a capturing control button;
responsive to a tap of the capturing control button, instruct the capturing device to capture a still image;
responsive to a continuous touch of the capturing control button, instruct the capturing device to capture a video footage throughout the continuous touch; and
responsive to a displacement movement applied to the capturing control button, instruct the capturing device to capture a video footage until a reverse displacement movement is applied to the capturing control button.

7. The system according to claim 6, wherein the capturing control button is configured to visually indicate throughout the capturing that a video footage is being captured by the capturing device.

8. The system according to claim 6, wherein the capturing control button is configured to move to a proximal location on the touch screen responsive to the displacement movement applied thereto.

9. The system according to claim 6, wherein the displacement movement comprises dragging the capturing control button from a first location to a second location on the touch screen, and wherein the reverse displacement movement comprises dragging the capturing control button from the second location to the first location on the touch screen.

10. The system according to claim 7, wherein the capturing control button is configured to visually indicate that a video footage is being captured by changing a color or appearance thereof.

11. The system according to claim 11, wherein the capturing device, the touch screen and the computer processor are implemented as a part of a smartphone.

12. A non-transitory computer readable medium comprising a set of instructions that, when executed, cause at least one processor to:
present on a touch screen a capturing control button;
responsive to a tap of the capturing control button, instruct a capturing device to capture a still image;
responsive to a continuous touch of the capturing control button, instruct the capturing device to capture a video footage throughout the continuous touch; and
responsive to a displacement movement applied to the capturing control button, instruct the capturing device to capture a video footage until a reverse displacement movement is applied to the capturing control button.

13. The non-transitory computer readable medium according to claim 12, wherein the capturing control button is configured to visually indicate throughout the capturing that a video footage is being captured by the capturing device.

14. The non-transitory computer readable medium according to claim 12, wherein the capturing control button is configured to move to a proximal location on the touch screen responsive to the displacement movement applied thereto.

15. The non-transitory computer readable medium according to claim 12, wherein the displacement movement comprises dragging the capturing control button from a first location to a second location on the touch screen, and wherein the reverse displacement movement comprises dragging the capturing control button from the second location to the first location on the touch screen.

16. The non-transitory computer readable medium according to claim 13, wherein the capturing control button is configured to visually indicate that a video footage is being captured by changing a color or appearance thereof.
